(19) United States
(12) Patent Application Publication
(10) Pub. No.: US 2011/0313880 A1
(43) Pub. Date: Dec. 22, 2011

(54) SYSTEM AND METHOD FOR SELECTING TRANSPORTATION RESOURCES

(76) Inventors: SUNIL PAUL, San Francisco, CA (US); Nitesh Mehta, Oakland, CA (US); Jason Starr, Belmont, CA (US)

(21) Appl. No.: 13/114,021

(22) Filed: May 23, 2011

Related U.S. Application Data
(60) Provisional application No. 61/347,786, filed on May 24, 2010.

(51) Int. Cl. G06F 15/16; G06Q 30/00

(52) U.S. Cl. 705/26.7; 709/203

(57) ABSTRACT

Embodiments of the present invention include various steps, which will be described below. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

### PRIORITY

This Application claims priority from Provisional Application Ser. No. 61/347,786, filed May 24, 2010, entitled “A System And Method For Selecting Transportation Resources.”

### DETAILED DESCRIPTION OF PREFERRED EMBODIMENTS

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Embodiments of the present invention include various steps, which will be described below. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

### BRIEF DESCRIPTION OF THE DRAWINGS

A better understanding of the present invention can be obtained from the following detailed description in conjunction with the following drawings, in which:

FIG. 1 illustrates an exemplary network architecture used to implement elements of the invention.

FIG. 2 illustrates an exemplary computer system for implementing embodiments of the invention.

FIG. 3 illustrates a transportation monitoring service according to one embodiment of the invention.

FIG. 4 illustrates a graphical user interface employed in one embodiment of the invention.

FIG. 5 illustrates a graphical user interface employed in one embodiment of the invention.

FIGS. 6-15 illustrate additional graphical user interface features according to different embodiments of the invention.

### AN EXEMPLARY NETWORK ARCHITECTURE

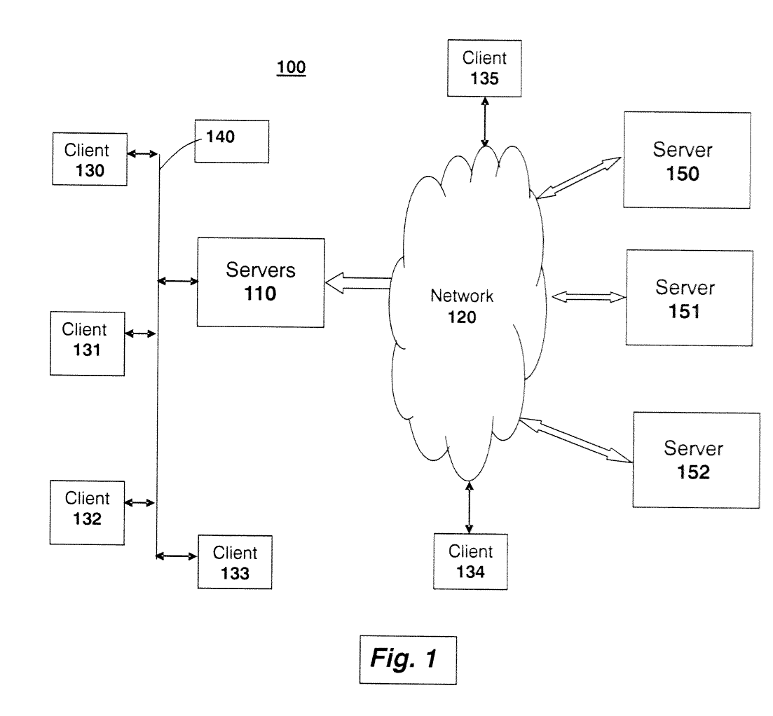

Elements of the present invention may be included within a client-server based system 100 such as that illustrated in FIG. 1. According to the embodiment depicted in FIG. 1, one or more servers 110 communicate to a plurality of clients 130-135. The clients 130-135 may transmit and receive data from servers 110 over a variety of communication media including (but not limited to) a private network 140 (e.g., a local area network) and/or a public network 125 (e.g., the Internet). In some of the embodiments described below, the clients 130-135 are automobiles equipped with a wireless (RF) communication interface and the network 140 is a wireless network such as a digital cellular network or WiFi network. In one embodiment, one or more of the clients 135-135 are mobile devices such as iPhone® or RIM Blackberry® devices which execute software to implement the embodiments of the invention described herein. Alternative communication channels such as wireless communication via satellite broadcast (not shown) are also contemplated within the scope of the present invention.

Servers 110 may include a database (not shown) for storing various types of data. This may include, for example, specific client data (e.g., client account information and client preferences) and/or more general data. The database on servers 110 in one embodiment runs an instance of a Relational Database Management System (RDBMS), such as Microsoft™ SQL-Server, Oracle™ or the like.

A user/client may interact with and receive feedback from servers 110 using various different communication devices and/or protocols. According to one embodiment, a client connects to servers 110 via client software. The client software may include a browser application such as Mozilla Firefox™ or Microsoft Internet Explorer™ on the user's personal computer which communicates to servers 110 via the Hypertext Transfer Protocol (hereinafter “HTTP”). In this embodiment, the servers 110 include Web servers. In other embodiments included within the scope of the invention, clients may communicate with servers 110 via cellular phones and pagers (e.g., in which the necessary transaction software is embedded in a microchip), handheld computing devices, and/or touch-tone telephones. For example, an application may be specifically designed to operate on a specific type of mobile device (e.g., an iPhone) and communicate with one or more of the servers when performing the operations described herein.

Servers 110 may also communicate over a larger network (e.g., network 125) to other servers 150-152. The servers 110, 150-152 may execute program code for performing the steps described below. It should be noted, however, that the underlying principles of the invention are not limited to any particular hardware/software implementation.

### AN EXEMPLARY COMPUTER ARCHITECTURE

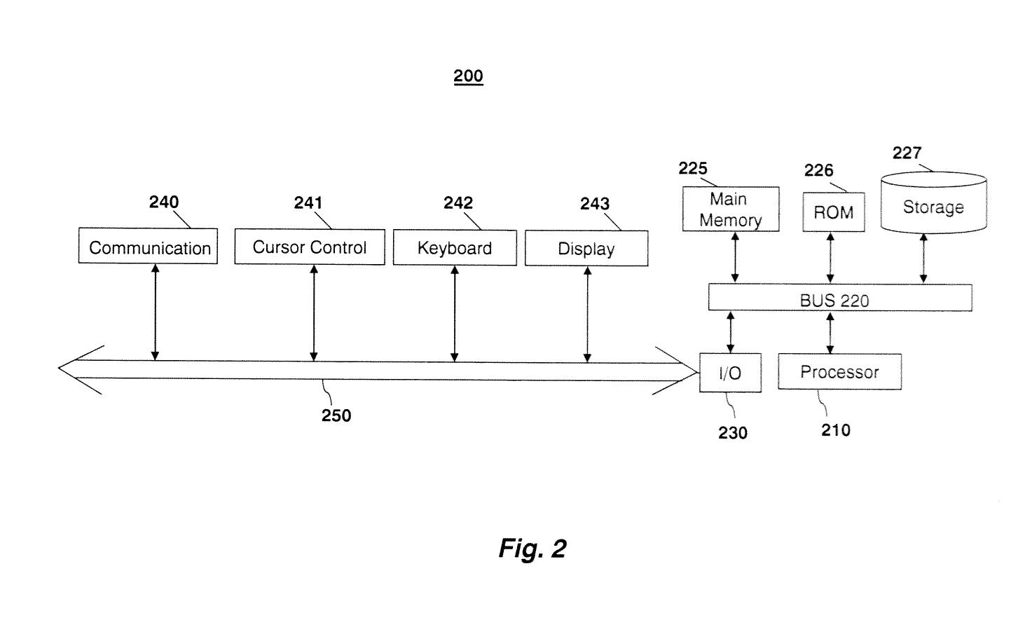

Having briefly described an exemplary network architecture which employs various elements of the present invention, a computer system 200 representing exemplary clients 130-135, servers 110, and mobile devices, in which elements of the present invention may be implemented will now be described with reference to FIG. 2.

One embodiment of computer system 200 comprises a system bus 220 for communicating information, and a processor 210 coupled to bus 220 for processing information. Computer system 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Computer system 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Computer system 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). For example, video news clips and related information may be presented to the user on the display device 243.

The communication device 240 is for accessing other computers (servers or clients) via a network 125, 140. The communication device 240 may comprise a modem, a network interface card, or other well known interface device, such as those used for coupling to Ethernet, token ring, or other types of networks.

Various mobile devices may be used in conjunction with the embodiments of the invention described below including, by way of example and not limitation Apple iPhones™ and RIM Blackberries™.

### EMBODIMENTS OF THE SYSTEM AND METHOD FOR SELECTING TRANSPORTATION RESOURCES

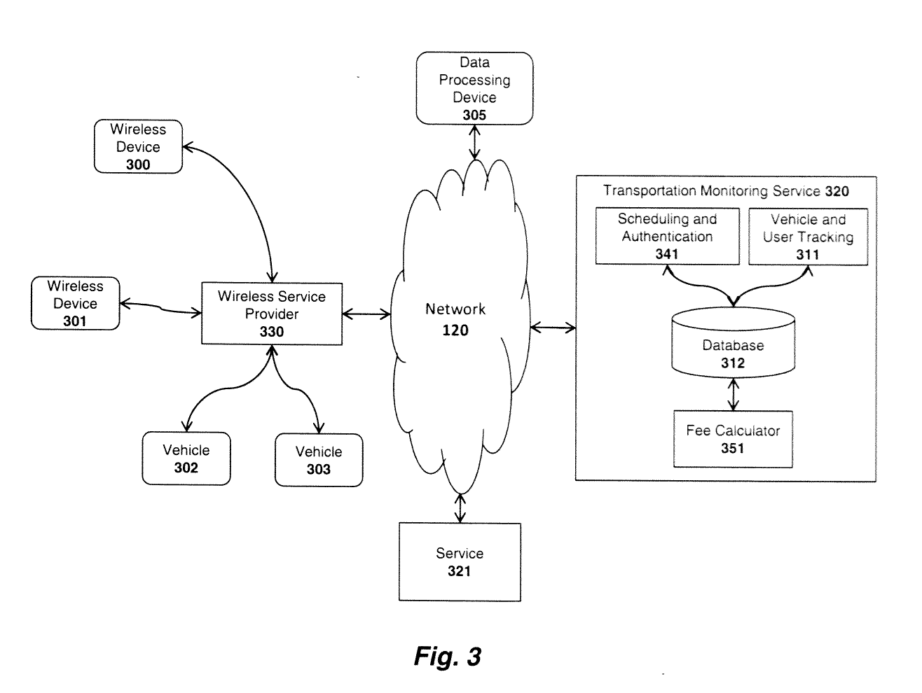

As illustrated in FIG. 3, in one embodiment of the invention, vehicles 302 and 303 are equipped with data processing and wireless communication functionality to enable communication with a transportation monitoring service 320. In one embodiment, vehicles 302-303 may be taxi cabs and may communicate their current location and/or availability to the transportation monitoring service. In addition, some of the vehicles 302-303 may be users participating in a car-sharing service in which the users agree to share rides with other users. In these embodiments, location tracking may be performed with user's mobile devices. The vehicles 302-303 may also be buses, trains, trollies, and/or other modes of transportation.

In one embodiment, the wireless devices 300-301 and vehicles 302-303 are equipped with location-based technology such as GPS and communicate their current location to the vehicle and user tracking module 311 executed on the transportation and monitoring service 230. The wireless devices 300-301 of user's seeking transportation may communicate with the transportation monitoring service 320 to provide their current location and to determine transportation options. Current vehicle and user locations and other relevant information (e.g., taxi availability) is stored within a database 312 on the transportation monitoring service 320. In addition to location-based tracking, the transportation monitoring service 320 may have access to transportation schedules for the vehicles (e.g., bus and train schedules) and may communicate with other services 321 which track the current locations of the vehicles (e.g., a taxi dispatcher service, a public transportation monitoring service, etc) and which track current transportation conditions (e.g., traffic conditions for cars, on-time conditions for trains and buses, etc). Various other techniques may be employed by the transportation monitoring service 320 to track the location of the wireless devices and vehicles. Moreover, while some embodiments of the invention are described using wireless devices 300-301, other computing devices 305 such as laptop and desktop computers may also be used.

As illustrated in FIG. 3, one embodiment of the transportation monitoring service 320 include a scheduling and authentication module 341 for authenticating users and for scheduling transportation options in response to user requests. For example, users may be required to establish an account on the transportation monitoring service and may be authenticated with a user ID and password. Once authenticated, user requests for transportation may be scheduled and submitted to vehicles 302-303 or other users 300-301. In addition, a fee calculator 351 may determine the cost associated with different transportation options described herein. For example, for buses, trains and other forms of transportation, the fees may be programmed into the fee calculator. For taxies and car-sharing, the fee calculator may calculate the fee using known techniques for these modes of transportation (i.e., based on the start and destination points for the trip).

One embodiment of the invention provides a requesting end user with a plurality of different transportation options given the user's current location and/or a desired destination. One embodiment of the invention, a transportation application is installed on mobile devices 300-301 to allow the mobile devices to communicate with the transportation monitoring service 320. In another embodiment, the application is simply a web browser installed on the mobile devices 300-301 and the transportation and monitoring service 320 exposes a Web-based interface to enable communication with Web browsers (e.g., using Web services protocols such as SOAP and/or using Representational State Transfer (REST)-based services.

In one embodiment, in response to a user requesting transportation via a mobile device 300-301, the transportation monitoring service will retrieve the mobile device's current location and query its database 312 for current transportation options. In one embodiment, the transportation monitoring service generates a Web-based GUI and transmits the Web-based GUI to the requesting device (e.g., in the case of a Web-based implementation where the mobile device accesses the transportation monitoring service via a Web browser). In another embodiment, the transportation monitoring service merely provides the transportation data to the mobile device and the mobile device formats the data based on a locally-installed GUI (e.g., in the case of a proprietary transportation application being installed on the mobile device).

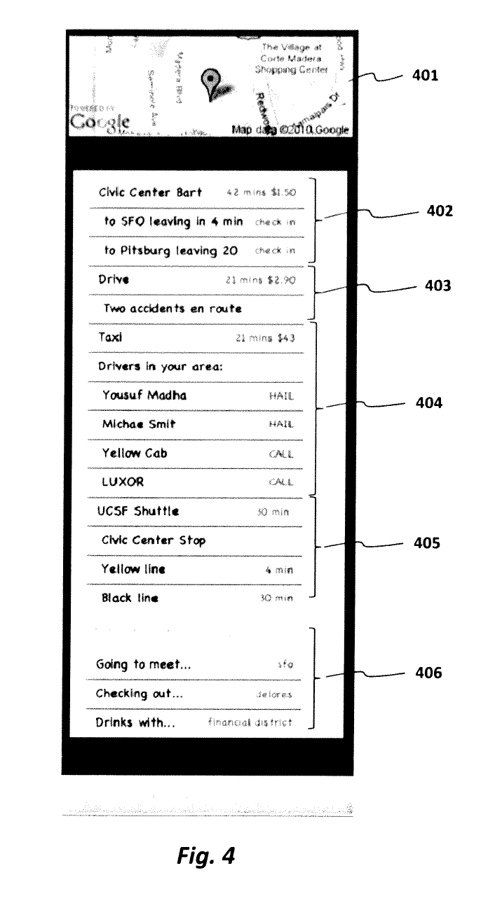

As illustrated in FIG. 4, one embodiment of the GUI includes a map 401 showing the requesting data processing device's current location and/or the desired destination (as specified by the user) and a plurality of different transportation options 402-405 from that location. In one embodiment, the transportation monitoring service 320 provides estimates for travel time and cost associated with each transportation option. As illustrated, the transportation options may include public transportation options such as trains 402 (showing Bay Area Rapid Transport (BART) options in the example) and driving options 403 along with the cost associated with the driving options (e.g., costs associated with gas consumption). In addition a set of options 404 associated to taxi services are provided along with options to hail individual taxis and/or to call the taxi services. In one embodiment, the transportation monitoring service tracks the location of taxis which are equipped with location tracking devices (e.g., GPS devices) and communicates information related to taxis within the vicinity of the user to the user's mobile device. In response to the user requesting to hail one of the taxis, the transportation monitoring service 320 may transmit a hail request to the requested taxi. The taxi driver may then respond in the affirmative to the transportation monitoring service 320 which will then forward the response to the user. In one embodiment, the location of the taxis is displayed within the map 401 so that the user can see where the taxis is currently located relative to their location. The taxi may similarly be provided with a map of the user's current location (so that the taxi may drive to the location of the user). In one embodiment, communication with the taxi occurs through a taxi service 321. That is, the taxi service 321 communicates with the taxi over the wireless network 330 and communicates with the transportation monitoring service 320 over another network (e.g., over the Internet using Web service protocols or RESTful communication protocols).

In addition to taxis, one embodiment of the transportation monitoring service provides locations of car-sharing users driving in the requesting user's area. The requesting user may then hail a car-sharing user to request a pickup at a particular location. In one embodiment, car-sharing users are selected based on both their current location and known destination (i.e., selecting users with similar locations and destinations as the requesting user). The car-sharing users may be shown within the map 401 along with the taxis and other transportation options.

In one embodiment, after a user has indicated a desired destination and the origin-destination pair is known, the transportation monitoring server 320 queries its database to match car drivers, taxi drivers, and/or passengers in taxis who are willing to share their trip with a passenger. These options are presented to the user and the user can reserve those shared trips with a single click. In response to that single click, the driver or taxi passenger may be notified.

Turning back to FIG. 4, in one embodiment, options for a bus or other shuttle service 405 may be displayed along with an indication of transportation times and locations.

Finally, information related to the user's “friends” is shown within region 406. In one embodiment, the user may maintain a list of friends on the transportation monitoring service 320 and/or an external social networking service (e.g., Facebook) in communication with the transportation monitoring service 320. The current locations and/or destinations of the user's friends may be identified and provided to the requesting user. Other information such as the carbon footprint associated with the modes of transportation, obstacles, announcements, and/or a “social map” of who is taking those modes of transportation may also be displayed.

The architecture described above may be used to implement a “one click” transportation information option. That is, the user may view available transportation options such as those shown in FIG. 4 with one click on a Web page hyperlink or application button. In response to the one click, the transportation monitoring service 320 may compile all of the relevant transportation information and provide it to the requesting mobile device.

The user is not required to enter a destination to be provided with transportation options. For example, in one embodiment, the transportation monitoring service 320 and/or an external service 321 feeds the requesting mobile device a list of neighborhoods or other points of interest (e.g. airports, cities) that are determined from either a list provided by the user and/or an algorithmic determination. User feedback may be captured and evaluated to understand popular destinations that originate from a particular location.

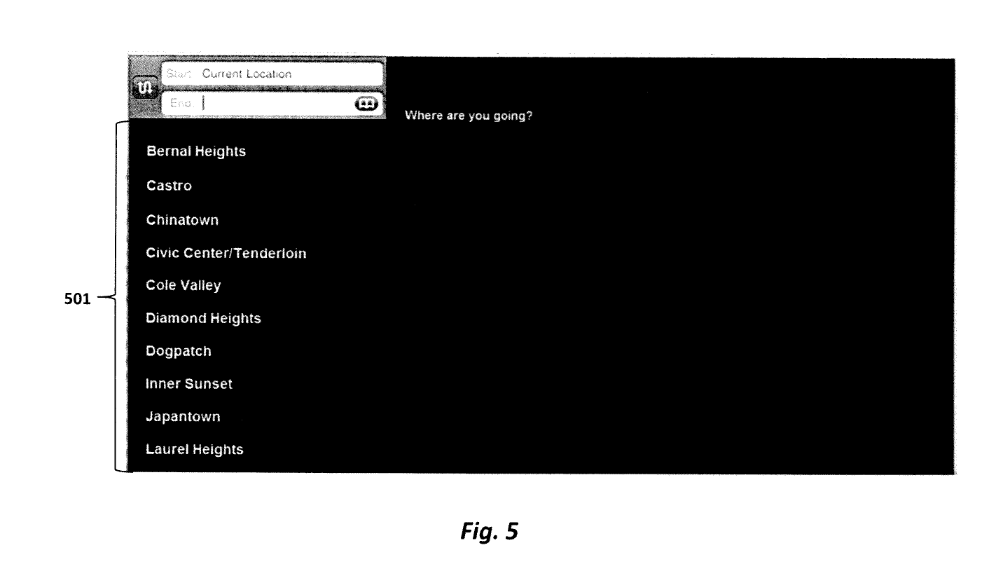

In one embodiment, the user clicking any of the locations (e.g., within the map 401 or listing) provides immediate information about the means of transportation to reach that destination. FIG. 5 illustrates one embodiment which provides a list of destinations generated based on (among other things), the user's current location and the likelihood that the user will want to choose one of the destinations in the list. Selecting one of the options from the list (e.g., “Casto”) may automatically generate the user interface shown in FIG. 4.

Once the user is provided with the information shown in FIG. 4, the starting point and the rough destination may be known. The user may then simply click on a transportation option such as a taxi to request transportation to the destination.

Various specific embodiments of the invention may be enabled by employ the architecture and method described above. One technique solves the problem of having to go through many transactions or “clicks” to understand which transportation resources are nearby and also available for the period of time you need for a given trip. An example would be carsharing such as Zipcar in many cities or City Carshare in the Bay Area. It could also be applied to rental of cars, bikes, and other conveyances. One mode of operation could be the following: (1) user indicates their destination; (2) the mobile device automatically generates an origin point or region; (3) the mobile device and/or the transportation monitoring service 320 determine the distance and travel time for each mode of travel; (4) display the availability of a car-share or other scheduled travel resource that is close by. The user may then be offered the opportunity to make a reservation and/or pay for the trip with a single click within the GUI shown in FIG. 4. In one embodiment, transportation resources may be identified with the following additional steps: (1) use the travel time with additional translation factors (e.g. 2× the travel time+walking travel time to the rental location) to determine the amount of time required for the reservation; (2) look up in a database 312 to locate vehicles (or other conveyances) that are available within a set search area; and (3) use pre-configured user payment information (e.g., credit cards), userID, passwords, etc. to reserve the “best available” vehicle. What is considered “best available” may be determined based on the user's preferences. For example, the best available may be the fastest in situations, the cheapest in other situations, and the lowest carbon footprint in other situations (or a logical combination of all of these variables).

One embodiment of the invention provides easier access to order various modes of transportation. By way of example, a method according to one embodiment of the invention includes the following steps:

(1) the user indicates one or more of their preferences for modes of travel. These preferences could be things like: take cabs or buses, or rail, or drive or shuttles, etc; take the least cost option; take the least travel time option; take the fewest connections option; avoid certain travel modes (buses, etc); avoid certain routes (e.g. the 43 bus); at night (or other designated hours) always take a cab; going to the Bronx always take a cab; going to JFK always take rail.

(2) Based on the detected location and user preferences and prior behavior (e.g. frequent visits to Capitol Hill), the user is presented with a single click option to go to various locations based on the mode preferences. As a result of this embodiment of the invention, a user can open the transportation application and get the information with no clicks and opportunity to order the appropriate mode of transportation with a single click. For example, a user who is located at Civic Center and has previously traveled to Berkeley, Palo Alto, and indicated a preference for the fastest modes of transportation might see the following options:
from Civic Center
to Berkeley
via BART 30 min
Departs in 5 minutes
to Palo Alto
by Car 45 minutes with traffic
to Chinatown
by Taxi 13 minutes with traffic
[ORDER]
to Financial District
by MUNI 5 minutes
departs in 3 minutes

Alternatively, the above interface may be displayed as a map 401 (as illustrated generally in FIG. 4) and the relevant information displayed as a result of clicking destinations on the map.

The embodiments described above may generate a pre-determined list of destinations. The following are some algorithms which may be used to create the list:

(1) Social mapping. Where are others in your social network tending to go? You are likely to go to similar places

(2) Passive tracking. Where are people who start in your location going based on GPS, cell, or other methods of travel tracking? This same data can be used to prioritize the list of destinations

(3) Distance vs. size. If a destination is large (e.g. LA), it is still notable even from a large distance. A small destination (e.g. Chinatown from Civic Center) is notable if its close by, even if small. So an algorithm for sorting destinations could include a ratio of population, area, density, or other measure of size and the distance between the locations.

(4) Past history of people using this or other applications and/or websites, etc.

(5) Media based mapping. Destinations with lots of mentions in media (web, twitter, TV, newspapers, etc) are more likely to be destinations . . . use data from these sources to prioritize the list

(6) Paid prioritization. Some destinations may desire to be on many lists and may be willing to pay for that placement. Prioritization could be based on some combination of payment.

Embodiments of the various servers and systems described above are implemented as software using computing architectures such as that illustrated in FIG. 3. It should be noted, however, that the underlying principles of the invention are not limited to the particular hardware or software configurations described herein. For example, the functionality described above may be implemented on a single server or across multiple networked servers; and the various modules of the transportation monitoring service 320 illustrated in FIG. 3 may be executed within a service 321 external to the transportation monitoring service 320. In such a case, the various services may exchange information over the Internet using Web services APIs.

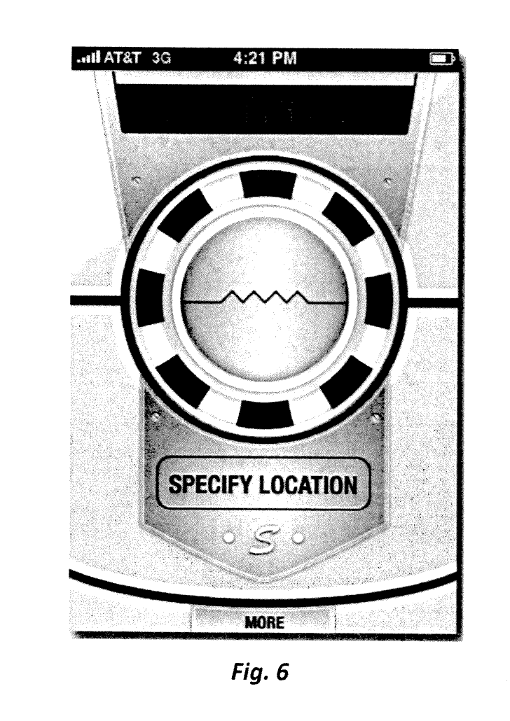

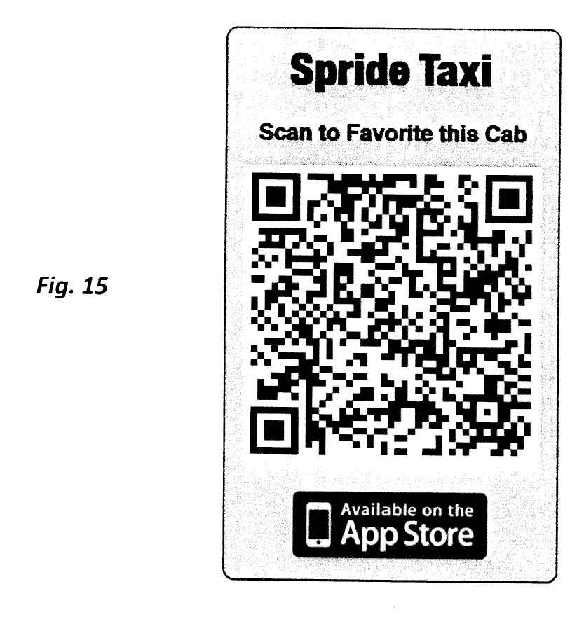

One embodiment of the invention is a taxi application which may be used to identify and hail taxis. This embodiment will now be described with respect to FIGS. 6-15.

The passenger application of this embodiment is tuned and designed for a single feature, hailing a single cab to a location. What we've seen with other applications is that their interfaces are bloated with functionality that is both confusing and difficult to quickly hail a cab, if they support functionality passed merely calling a company. We imagine the Spride Taxi app will be best of breed in this category and the design is meant to illustrate a distinct look and difference in approach to cab hailing. We expect this application to have a level of animation and interstitial transition to indicate status changes and progress.

### Main Screen—FIG. 6

The main application screen is a simple 1-2 button operation. The user need only set a location for their pickup or wait till the current location is determined. The main screen has a few variable states depending on what operation is being currently done. We see the flow as the user setting a location for pickup first, then hailing a Taxi to that location.

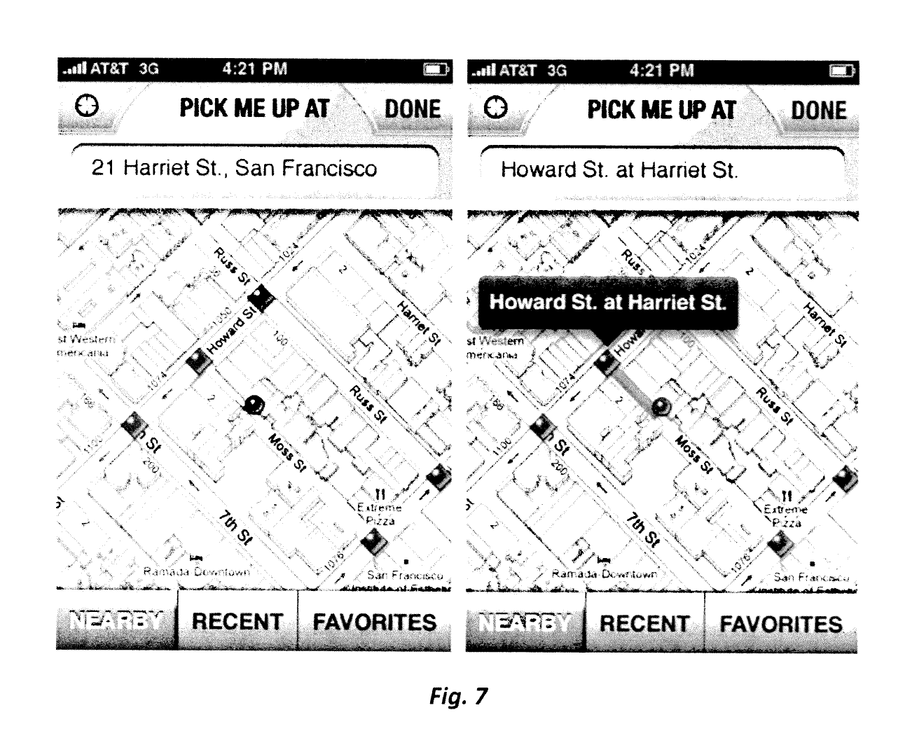

### Location Setting—FIG. 7

The application can automatically detect the passenger's location and recommend nearby major intersections or landmarks to be picked up at. This can include popular restaurants, bars, and more. This will minimize the need to type in a specific address or intersection and will make it easier for the taxi driver to find the passenger. In addition we will provide a list of recent locations that cabs have been hailed to and Favorite locations.

### Nearby Intersection

The nearby intersections screen illustrated in FIG. 7 shows the nearest corners to the user's locations. We like this approach better than a list because a the map helps the user to see exactly where that intersection is. Users of the application may not be familiar with the city they are in and therefore not be familiar with the nearest intersection. This interface allows users to choose

based on their location and travel direction. Tapping an intersection will display that name and change the location in the location bar.

### Recent Locations

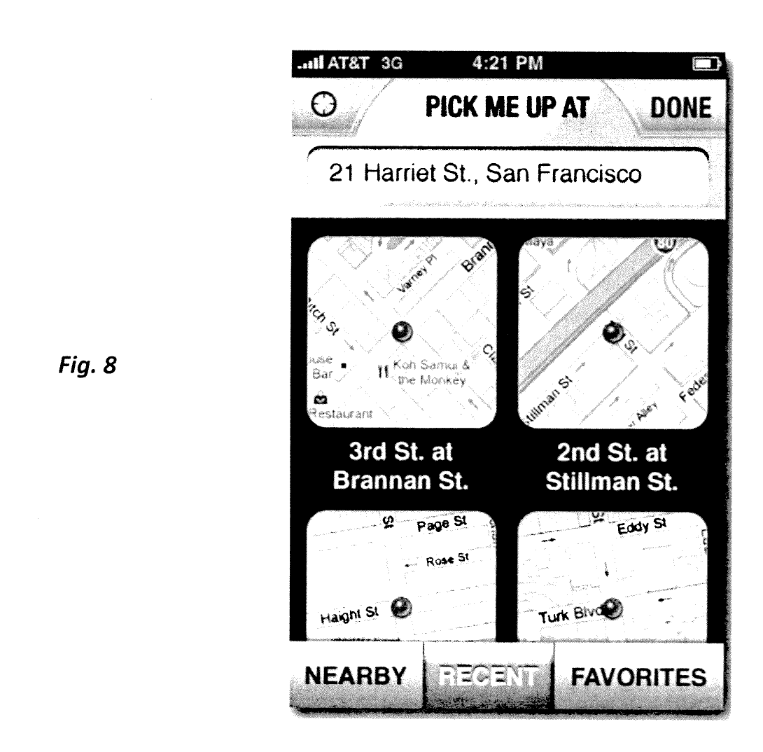

The recent locations screen illustrated in FIG. 8 shows the most recent locations the user has hailed cabs to. This list can be easily cleared by using the button at the bottom of the screen. These locations would be recognizable from their large thumbnails, showing the spot the cab is being hailed to. Tapping one of these locations changes the text in the location bar.

### Favorite Locations

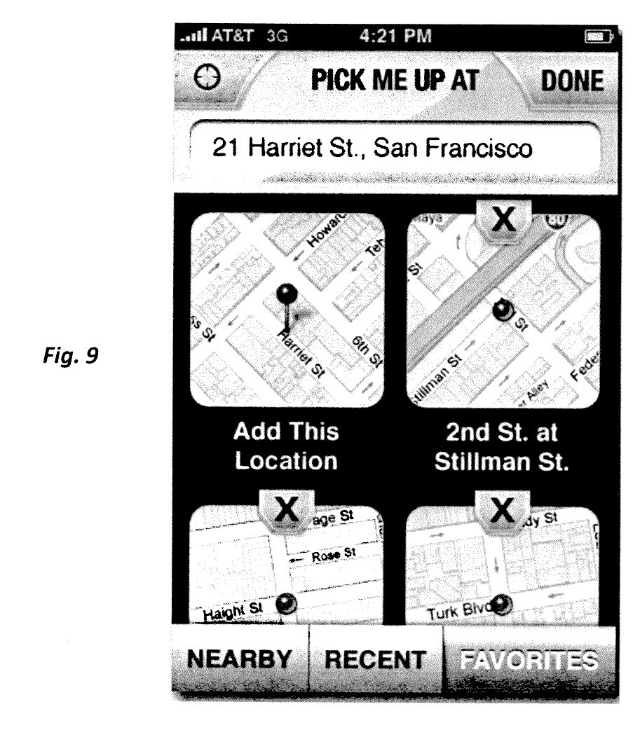

The favorite locations screen illustrated in FIG. 9 show locations a user wishes to constantly hail cabs to. Tapping the “Add to Favorites” button would add the current location in the location bar to their favorites list. This is a location where users can also remove locations by tapping the requisite removal interface. At the moment this is not final.

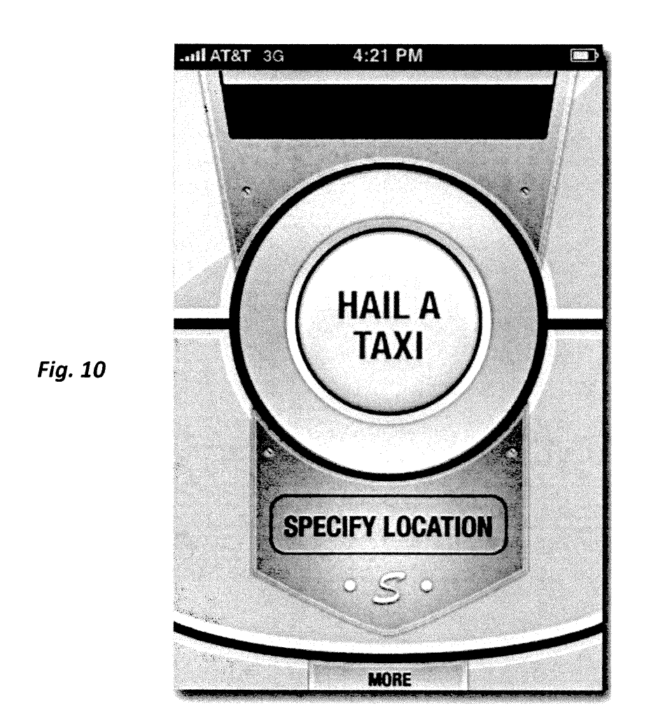

### Ready to Hail—FIG. 10

Once a location has been specified on the location screen the center grate in the main screen opens and the “HAIL A TAXI” button is shown. It is also possible to have the location sensing be more automatic and have this button show as soon as a reasonable location is determined. The location is displayed in the LED like interface above. Again we expect the animation on this to be smooth and engaging.

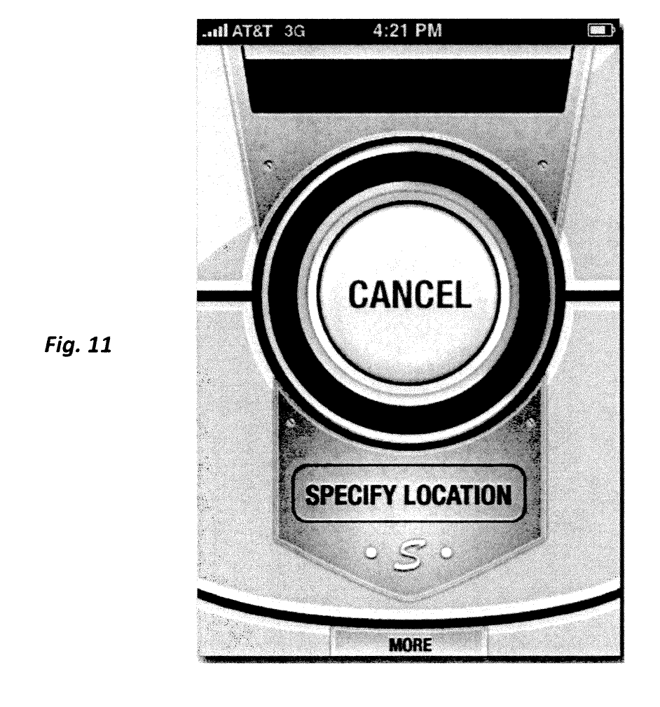

### Taxi Hailing in Progress—FIG. 11

Once the “Hail a Taxi” button is pressed the progress indication ring will be shown and will begin to progress as the server and client interact. As this is happening the button will change to cancel. Once a driver has been matched the screen will slide to the ride progress screen.

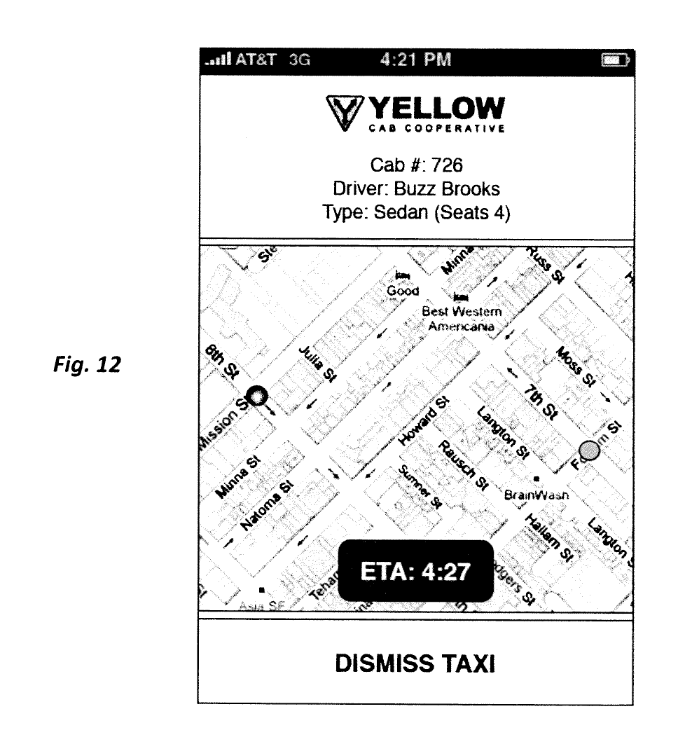

### Ride Progress Screen—FIG. 12

The ride progress screen shows metadata about the driver including their company, cab number, name, and vehicle type. This screen also shows the cab's approximate location and estimated time of arrival. In this screen the blue dot will indicate their pickup location and the yellow dot will indicate the cab's current location. This screen will also display a button to dismiss the taxi in the event that it is no longer required.

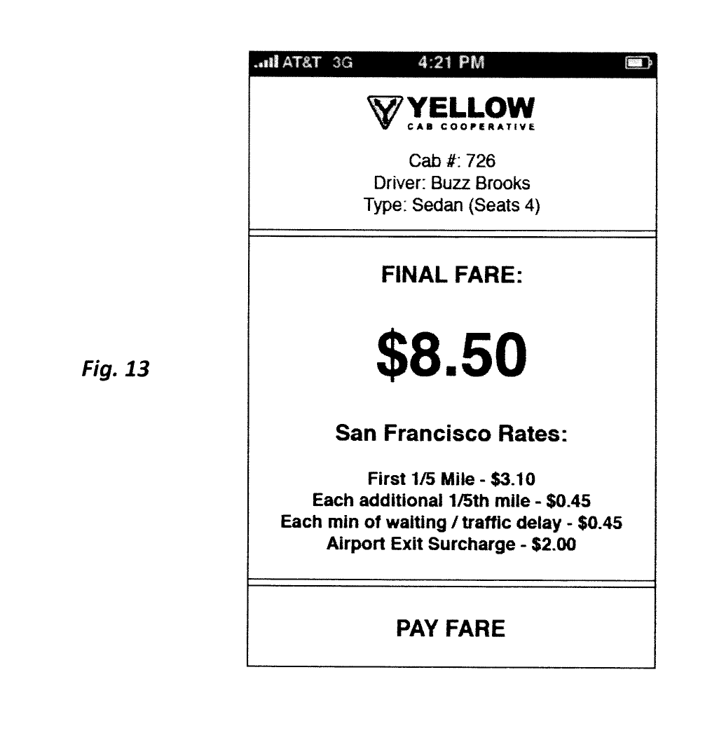

### Ride Pay Screen—FIG. 13

When the ride is completed and the driver has indicated the final price that information can be conveyed on the passenger's application where they will have an opportunity to pay the fare from their device. Every region has different cab rates, and although they are required by law to have those rates posted in the cab we believe a quick breakdown in the application would be useful information for a user. There might be a few issues with making sure this payment transaction works appropriately and provides options for cash payment, but we can iterate this screen as that becomes necessary.

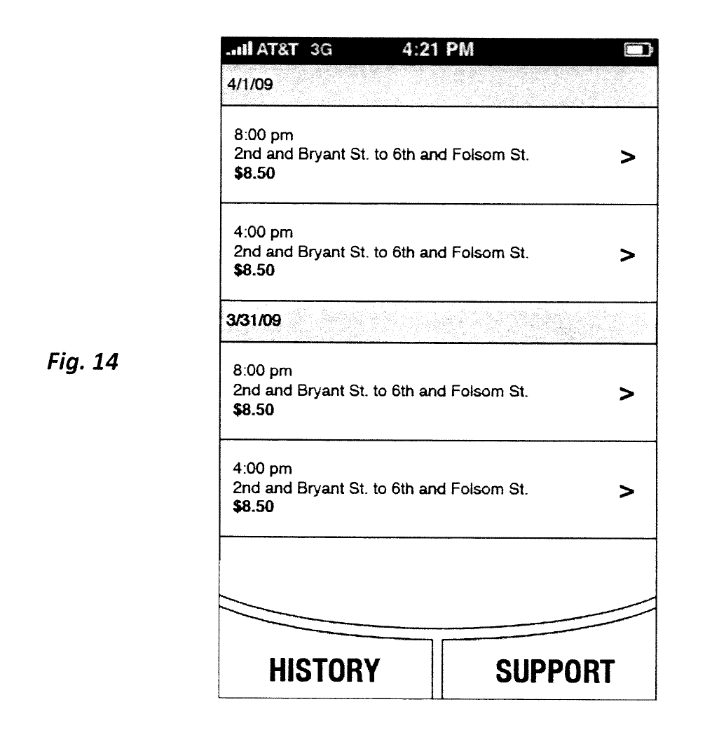

### Ride History Screen—FIG. 14

When toggling the history button we would animate out the taxi options and show the ride history screen, which gives users the opportunity to see what rides they have taken and is sorted by date and time. Selecting one of these rows will take the user to a detail screen similar to the ride detail screen, with information regarding their trip such as start and end points and their total cost. This screen may not be necessary until the pay screen has been added, to have the ride fare.

### Alternate Taxi Skins

Different users may prefer different cab styles. We can optionally design alternate skins for the application.

### Marketing Opportunities

The most important aspect of providing a Taxi driver and passenger experience is getting buy-in from drivers, and marketing to new users. Here are some proposed ways to do just that.

### Passenger & Incentives

### Invite a Driver

Users could easily invite a driver to the transportation monitoring service 320 driver network by using the application to send them a text message that would include a marketing message and a link to learn more about the application.

### Fare Credits

If a passenger invites a driver and that driver joins the network the passenger can then get a credit for a fare.

### Achievement and Collection Incentives

Another possible avenue to get users to try the transportation monitoring service 320 is to have an achievement system included where users get points or credits that can later be redeemed for a chance to win prizes.

### Driver Incentives

### Cab Stickers

A driver could receive stickers or a plaque to put in their cab displaying a code that users can scan once they've downloaded the application from the App Store. If this is the users first action after getting the application the driver then receives a credit.

### First User Experience

When a user first downloads the application there should be an easy way to quickly run them through the functionality so they understand how to proceed and what to expect.

### No Taxi Fail Over

When in a city that has no taxis using the transportation monitoring service 320 we should present the user with a list of cab companies in the area with numbers.

### Nearby Taxi View

Passengers may eventually be able to see nearby participating taxis on a map.

### Radius & Proximity Setting

Passengers should be given the option to specify the radius in which they are looking for a cab (default 15 minute “radius”) as well as the time before a cab shows up (default 1 minute).

### Taxi Number Large Type

To help the taxi driver find the passenger (and to help avoid stolen fares), the application can show the taxi number in large type in a very readable font and color scheme.

### Nearby Cab Alert

The application will alert the user when the cab is approximately one minute away.

### Favorite Drivers

Users can add drivers or vehicles they consider to be favorites. Favorites are favored and highlighted when responding to hailing requests. This will encourage drivers to promote the app among passengers since it will likely lead to repeat business.

### Support Screen

This screen should display information for issue resolution and what to do in common problem situations.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while a client-based implementation is described above, a server-based implementation (or other distributed computing implementation) is also contemplated within the scope of the present invention. Accordingly, the scope and spirit of the invention should be judged in terms of the claims which follow.

What is claimed is:

1. A computer-implemented method for selecting transportation resources comprising:
equipping a plurality of vehicles with location detection and wireless communication functionality;
each of the plurality of vehicles detecting its current location and communicating its current location to a transportation monitoring service;
providing a transportation application to a plurality of wireless client devices, the transportation application communicating with the transportation monitoring service;
wherein, in response to detecting a request from a first transportation application executed on a first wireless client device, the transportation monitoring service generates a plurality of transportation options for a user of the wireless device, the transportation options generated, at least in part, on the current detected location of the user of the first wireless client device.

2. The method as in claim 1 wherein the plurality of options comprise a plurality of public transportation options and a plurality of non-public transportation options.

3. The method as in claim 2 wherein the plurality of public transportation options are selected from a group consisting of bus options and train options.

4. The method as in claim 3 wherein the plurality of non-public transportation options are selected from a group consisting of rental car options, taxi options, and ride sharing options.

5. The method as in claim 1 wherein the transportation monitoring service provides the options for the user in the form of a map indicating the location of each of the different transportation options.

6. The method as in claim 1 wherein the transportation monitoring service provides a time associated with one or more of the transportation options.

7. The method as in claim 1 wherein the transportation monitoring service generates the plurality of transportation options based on current user preferences related to different modes of transportation.

8. The method as in claim 7 wherein transportation monitoring service generates the plurality of transportation options based on prior user behavior with respect to transportation options.

9. The method as in claim 1 wherein the transportation monitoring service prioritizes the plurality of transportation options based on the speed with which transportation of the user will occur under each of the plurality of transportation options.

10. The method as in claim 1 wherein the transportation monitoring service generates the plurality of transportation options based on both the speed with which transportation of the user will occur and the cost associated with each of the plurality of transportation options.
